(19) United States
(12) Patent Application Publication
(10) Pub. No.: US 2010/0200786 A1
(43) Pub. Date: Aug. 12, 2010

(54) PRESSURE-SENSING VALVE AND THE METHOD FOR USING THE SAME

(76) Inventor: Pao-Lai Chen, Pingtung County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 12/760,702

(22) Filed: Apr. 15, 2010

Related U.S. Application Data
(63) Continuation-in-part of application No. 11/729,685, filed on Mar. 29, 2007, now Pat. No. 7,726,288.

(30) Foreign Application Priority Data
Jan. 15, 2007 (TW) 096101502

(51) Int. Cl. F16K 31/44; F16K 25/00; F01L 3/10

(52) U.S. Cl. 251/73; 251/157; 251/337

(57) ABSTRACT

A pressure-sensing valve comprises a first housing part, a second housing part, a first regulating knob, a second regulating knob, a valve piston, an upper washer and lower washer, and a pair of springs. The housing parts each has an inner space for moveably receiving the other elements therebetween, and connected with the regulating knobs by a threaded portions. The regulating knobs adjustably abut against the opposite ends of the pair of springs to shift the balanced position thereof to a gating position for closing the pressure-sensing valve under a desired compressed length of the springs and opening for temporarily responding to the acceleration of engine.

### CROSS-REFERENCE TO RELATED APPLICATIONS

This application is a continuation-in-part of U.S. patent application Ser. No. 11/729,685 filed on Mar. 29, 2007, entitled “INTAKE REGULATING SYSTEM OF ENGINE”, the disclosure of which is incorporated by reference herein.

### FIELD OF THE INVENTION

The invention relates to pressure-sensing valve and the method for applying it in an intake regulating system of engine, and more particularly, to a pressure-sensing valve which has a pair of springs biased on opposite sides of a valve piston for adjusting the sensibility thereof by a pair of regulating knobs to move the balanced position between the springs. Responding to the fluctuation of sucking force of the engine, during a sharp acceleration is proceeding, the pressure-sensing valve supplies supplementary air to the intake manifold temporarily and thereafter stops the air supply automatically.

### DESCRIPTION OF THE RELATED ART

When the accelerator pedal of a vehicle is stepped on to accelerate the engine from its idle state sharply, the air-fuel mixture being supplied to the engine becomes too rich due to the air supply from the intake air passage can not supply a sufficient air in time to achieve accurate air-fuel ratio. This causes an increase amount of un-burnt ingredients in the exhaust gases.

A known intake regulating system of engine as shown in FIG. 1, and a pressure-sensing valve (1) with a structure as shown in FIG. 2, can be apply to solve the forementioned problem. The pressure-sensing valve of FIG. 2 includes a housing (11), a pair of springs (12) and (13), a valve piston (14), and a valve regulating knob (15).

The housing (11) is formed with an inlet hole (110), an outlet hole (111) and a slender hole (112). The outlet hole (111) and the slender hole (112) are adapted to communicate with the intake manifold (23) of engine (2).

The valve piston (14) is slidably received within the housing (11) and biasing by the springs (12) and (13) for opening and closing the air passage between the inlet hole (110) and outlet hole (111).

The upper end of the valve piston (14) includes an air-tight slider (141) for prohibiting the air communication between the outlet hole (111) and the slender hole (112) in the housing (11). The lower end of the valve piston (14) is formed with a conic surface (144) which can open and close the air passage between the inlet hole (110) and outlet hole (111).

During intake strokes, the piston of engine (2) is moving downward to draw the air from the main air cleaner (21) through the air pipe (210), the throttle (22), the intake manifold (23), and finally to the air inlet (20) to mix with fuel and then to be sucked into the engine (2) for combustion and generating power.

The crankcase (28) communicates with the air pipe (210) via a breather hose (24) to discharge the gas and oil vapour accumulated therein to the air pipe (210). Once the oil vapour comes across the cold air-flow, may then condense and dirt the inner wall of the air pipe (210), this can deteriorate the air-flow rate in the air pipe (210).

Again, once the accelerator pedal is stepped on to accelerate the engine (2) sharply from an idle state, the air in the pressure-sensing valve (1) will suddenly to be drawn into the intake manifold (23) through both the outlet hole (111) and slender hole (112) simultaneously. However, the velocity of the air-flow in the slender hole (112) is much slower than the air-flow in the outlet hole (111), thus causes the air pressure above the air-tight slider (141) higher than the down side temporarily, and creates a force to moving down the valve piston (14) temporarily, until the air pressures get balanced.

When the valve piston (14) is moving downward to an opening position, the pressure-sensing valve (1) has put in an opened state.

Once the valve piston (14) has moved to the opening position, the inlet hole (110) can then suck in the outside air through the air cleaner (1101) temporarily. The valve piston (14) can move back to its closing position automatically under the biasing forces of the springs (12 and 13) as soon as the air pressure of the upper side and down side of the air-tight slider (141) get balance by time.

There are also some other types of pressure-sensing valves illustrated in U.S. Pat. Nos. 2,362,558 and 4,856,487. In U.S. Pat. No. 2,362,558 the pressure-sensing valve is used to regulate a mixture flow of an air-fuel from a carburetor to an intake manifold of an engine, which has a vacuum chamber defined by a flexible diaphragm and communicate with a throttle valve, wherein the flexible diaphragm is biased by one spring to close the valve thereof.

In U.S. Pat. No. 4,856,487 the pressure-sensing valve (a PCV valve) keeps in open state until the engine stops, and can not close the air passage therein automatically. Due to said patented pressure-sensing valve does not open temporarily for responding to the acceleration of engine (2) and close automatically thereafter, could not use in the intake regulating system of engine as shown in FIG. 1.

Normally, different engine has its different sucking force while in acceleration, i.e. the newer or bigger one may provide relative higher sucking force, and the older or smaller one may provide relative weaker sucking force. The pressure-sensing valve (1) disclosed in FIG. 2 has only one regulating knob (15) for adjusting the balanced position (B1) of the springs (12 and 13) to a gating position (G1) to close the valve (1). As the known pressure-sensing valve (1) disclosed in FIG. 2 has only one compressed length (L1) of the springs relative to the gating position (G1) to provide specific biasing force, therefore would not possible to adjust sensibility thereof as desired.

As schematically illustrated in FIG. 3, the balanced position (B1) between the pair of springs (12 and 13) of FIG. 2 can bring the valve piston (14) to the gating position (G1) to close the valve (1) by adjusting the valve regulating knob (15) to compress and uncompress the springs (12 and 13) to a specific compressed spring length (L1). As the sucking force provided by the older and smaller engine may be too weak to open the same valve in time, once a pressure-sensing valve (1) is suitable for applying in a specific intake regulating system with newer and bigger engine, may not be applicable for another older and smaller engine and vice versa. If the pressure-sensing valve cannot open in time as soon as the acceleration taking place and close thereafter automatically, This result would deteriorate and fail the effect of the intake regulating system of engine illustrated in FIG. 1.

### SUMMARY OF THE INVENTION

An object of the present invention is to provide a pressure-sensing valve of which can be adjust the sensibility by changing the balanced position with different compression length of spring as desired, so as to make it be suitable for applying in intake regulating systems with different conditions of engine.

According to the present invention, the pressure-sensing valve may comprise: a first housing part, a second housing part, a first regulating knob, a second regulating knob, a valve piston, an upper washer and lower washer, and a pair of springs. The housing parts each has an inner space for moveably receiving the other elements therebetween, and connected with the regulating knobs by threaded portions. The regulating knobs are adjustably adapted on the opposite ends of the pair of springs via the washers to shift the balanced position thereof to a gating position for closing the pressure-sensing valve under a desired compressed length of the springs and opening for temporarily responding to the acceleration of engine.

### BRIEF DESCRIPTION OF THE DRAWINGS

The accomplishment of this and other objectives and the range of suitability of the application of the invention will become apparent from the following description and its accompanying drawings of which:

FIG. 1 is schematically illustrating a known intake regulating system of engine;

FIG. 2 is a vertical cross-sectional view of the known pressure-sensing valve which can be used in known intake regulating system;

FIG. 3 is schematically illustrating the known pressure-sensing valve being adjusted the balanced position to a gating position under a specific compressed length of the springs thereof;

FIG. 4 is schematically illustrating a pressure-sensing valve according to the present invention can adjust the balanced position to a gating position with more than one compressed lengths of the springs;

FIG. 5 is an exploded cross-sectional views of an embodiment of the pressure-sensing valve according to the present invention;

FIG. 6 is an assembled cross-sectional view of the pressure-sensing valve shown in FIG. 5;

FIG. 7 is schematically illustrating the pressure-sensing valve in an open state responding to an acceleration temporarily, and which close automatically thereafter;

FIG. 8 is schematically illustrating a pressure-sensing valve in accordance with the present invention applied in an intake regulating system of engine;

FIG. 9 is schematically illustrating a pressure-sensing valve in accordance with the present invention applied in an intake regulating system of engine, wherein the crankcase has a breather hose has connected to an inlet hole of the pressure-sensing valve for recycling the oil vapor in the engine for combustion with air-fuel mixture.

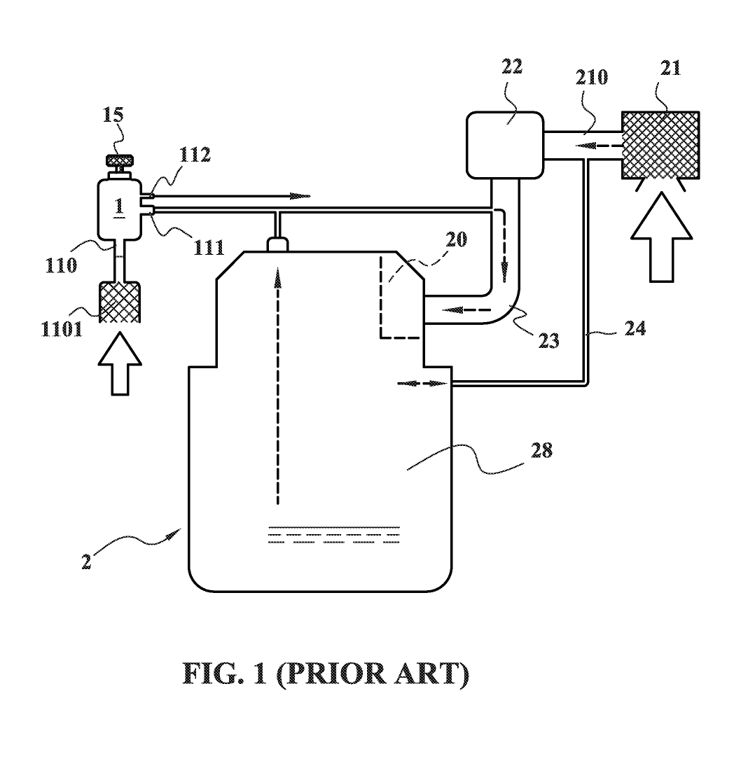

### DETAILED DESCRIPTION OF THE PREFERRED EMBODIMENT

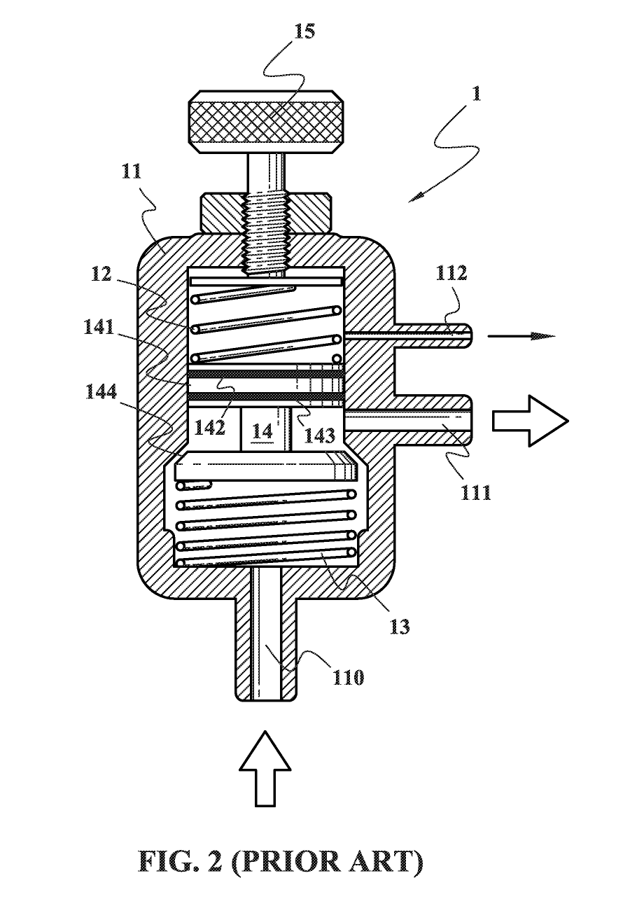

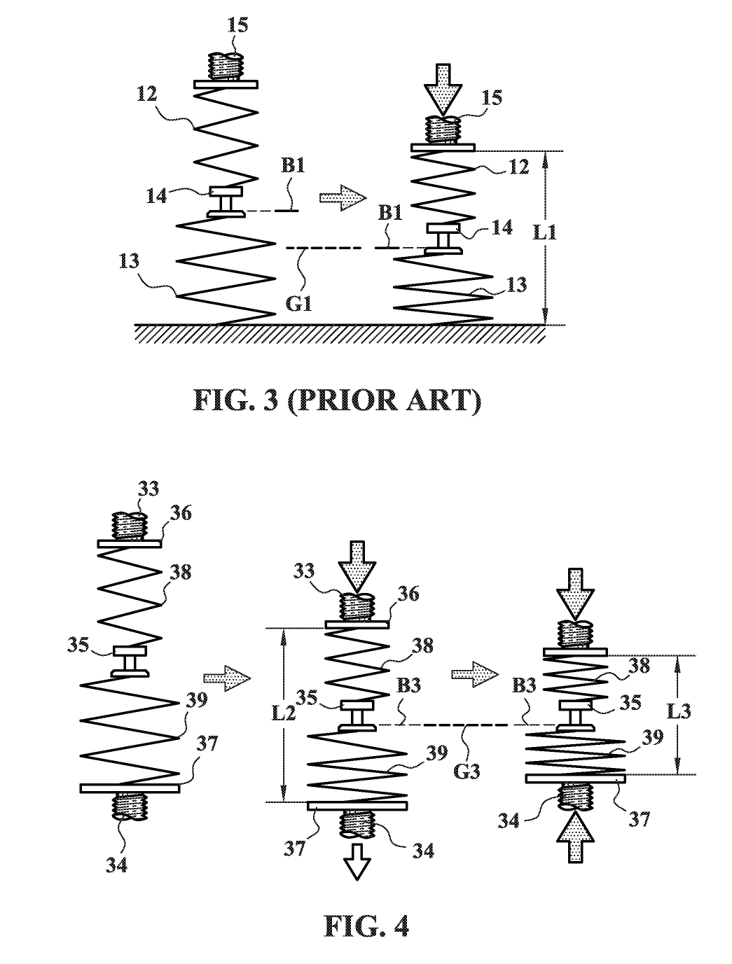

FIG. 3 schematically illustrating the known pressure-sensing valve (1) of FIG. 2 has adjusted the valve piston (14) from a balanced position (B1) to a gating position (G1) under a specific compressed length (L1) of the springs (12 and 13). If the sucking force of the engine is too weak, the pressure-sensing valve may not be open during acceleration. However, if the sucking force of the engine is too strong, the pressure-sensing valve may always keep open slightly even though there are no acceleration is proceeding. This problem would deteriorate the effect of the known pressure-sensing valve (1) and may lower the air-fuel ratio to cause an unsteady running under idle state of an engine.

FIG. 4 is schematically illustrating a pressure-sensing valve (3) according to the present invention can adjust the valve piston (35) from a balanced position (35) to a gating position (G3) under more than one compressed lengths (such as L2 and L3 shown in this drawing) of the springs (38 and 39) as desired.

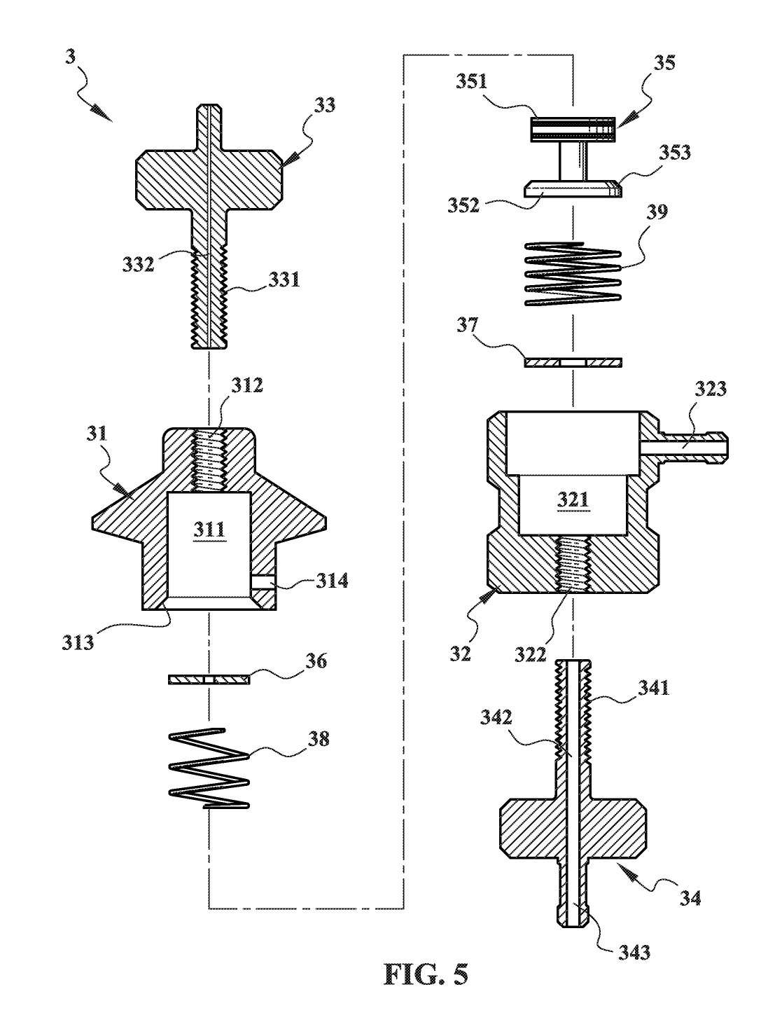

Referring to FIGS. 4 to 6, the pressure-sensing valve (3) according to the present invention may include: a first housing part (31), a second housing part (32), a first regulating knob (33), a second regulating knob (34), a valve piston (35), an upper washer 36 and lower washer (37), and a pair of springs (38 and 39).

The first housing part (31) has an inner space (311) for moveably receiving the upper washer (36), a side opening (314) for directing the air in the inner space (311) to outside, the spring (38) and the valve piston (35), and an upper threaded hole (312) for engaging with the first regulating knob (33). Further, the lower end of the first housing part (31) has formed with a conic surface (313) for engaging with the gating portion (352) of the valve piston (35) thereby to close the air passage between the inlet hole (343) and the outlet hole (323).

The second housing part (32) has an inner space (321) for receiving and engaging with the lower portion of the first housing part (31) and moveably receiving the lower washer (37) and the spring (39) therein, and an outlet hole (323) communicated with the inner space (321) through the side opening (314). Furthermore, the first housing part (32) formed with a lower threaded hole (322) for engaging with the second regulating knob (34).

The first regulating knob (33) has a first threaded bolt (331) and a slender air passage (332) formed therethrough in axis. The first threaded bolt (331) can be threadly engaged with the upper threaded hole (312) thereby to adjust back and forth into the inner space (311), to abut the upper washer (36) as well as the spring (38).

The second regulating knob (34) has also a threaded bolt (341) and an air passage (342) formed therethrough in axis. The threaded bolt (341) can be threadly engaged with the lower threaded hole (322) thereby to adjust back and forth into the inner space (321), to abut the lower washer (37) as well as the spring (39).

The valve piston (35) has an air-tight slider (351) and a gating portion (352). The gating portion (352) has formed with a conic surface (353) which can engage with the conic surface (313) to close the air passage between the inlet hole (343) and the outlet hole (323), while the valve piston (35) is moved to the gating position (G3).

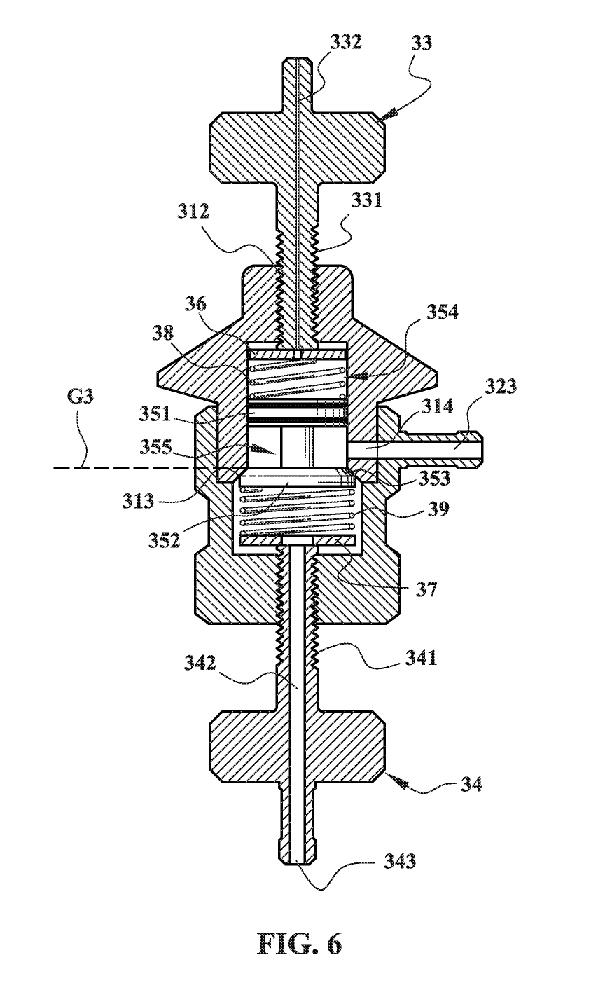

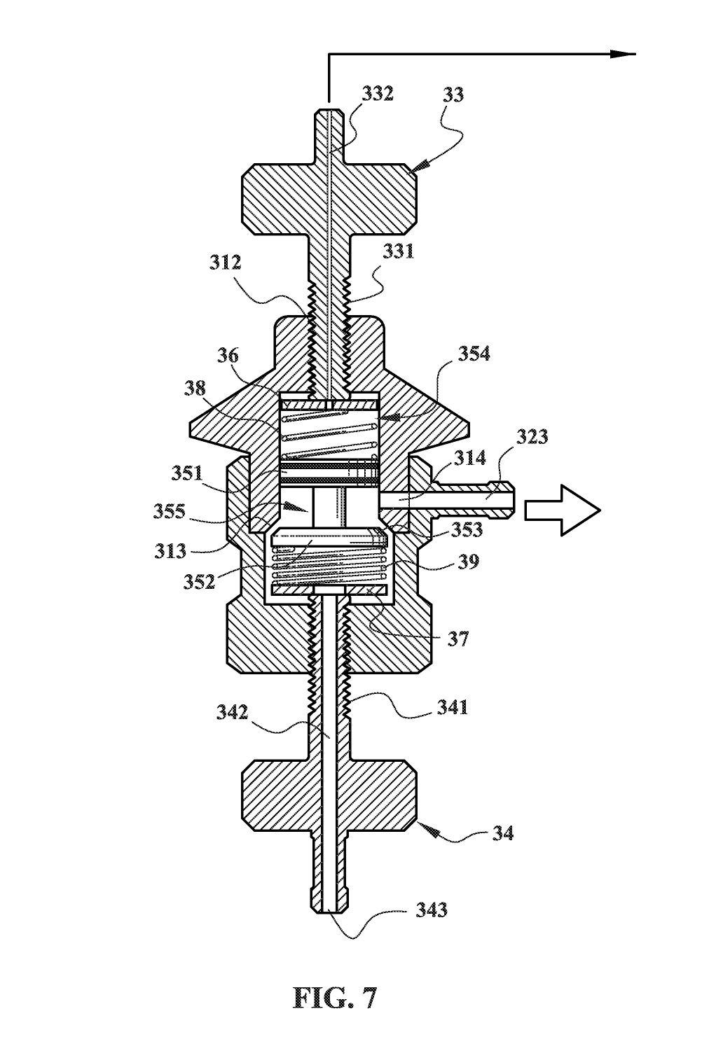

Referring to FIG. 6, the air-tight slider (351) divides the inner space (311) into upper space (354) and lower space (355). When in acceleration, there is a suddenly enlarged sucking force sucks the air from the spaces (354 and 355) through the outlet hole (323) and the slender air passage (332) simultaneously. As the air-flow in the slender air passage (332) keeps very slow, causes the air pressure in upper space (354) relatively larger than the pressure in lower space (355), this will move the valve piston (35) downward thereby to open the air passage between the inlet hole (343) and the outlet hole (323), as shown in FIG. 7.

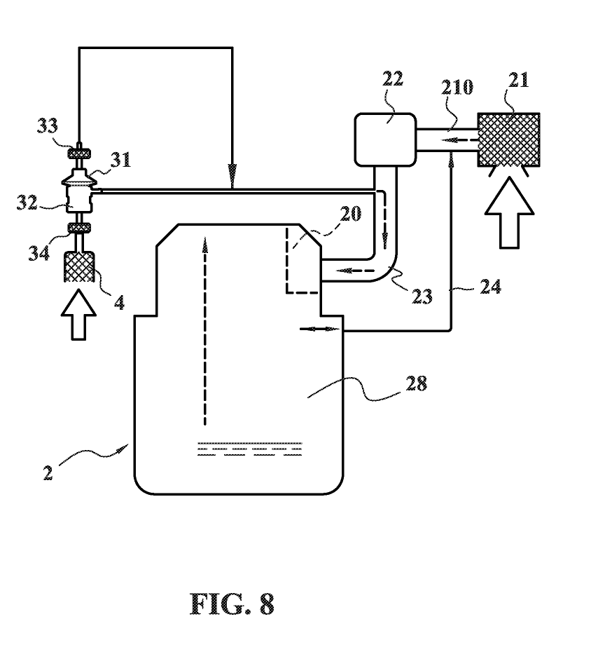

The method for using the pressure-sensing valve (3) of the present invention, includes the steps of: connecting and adjusting. In the connecting step, the slender air passage (332) and the outlet hole (323) is connected to an intake manifold (23), and a second air cleaner (4) is connected to the inlet hole (343) as shown in FIG. 8. In the adjusting step, the first regulating knob (33) and the second regulating knob (34) is rotated to adjust the valve piston (35) to a gating position (G3).

The method may further include a step of compressing the pair of springs (38 and 39) to a desired compressed length (L3) by rotating the first regulating knob (33) and the second regulating knob (34). By this step, to keep the valve piston (35) in the gating position (G3) with a suitable compressed length (L3), to allow the gating portion (352) of the valve piston (35) disengaged from the conic surface (313) temporarily during the engine (2) is in acceleration, and thereafter to engage again automatically.

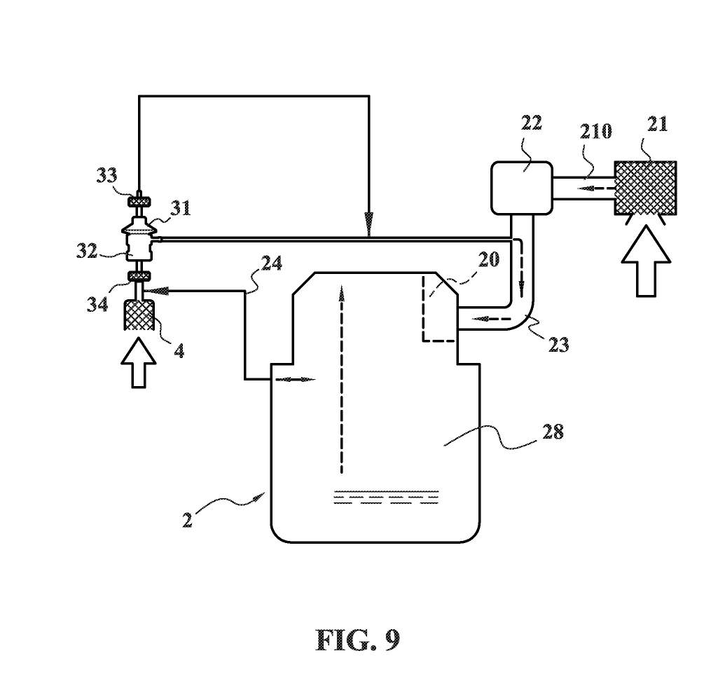

Preferably, the connecting step further include connecting the crankcase 28 via a breather hose (24) to the inlet hole (343), as shown in FIG. 9, to direct the oil vapor to the engine (2) for re-combustion with the air-fuel mixture when the engine is in acceleration.

It will become apparent to those people skilled in the art that various modifications and variations can made to the mechanism of the invention without departing from the scope or spirit of the invention. In view of the foregoing description, it is intended that all the modifications and variation fall within the scope of the following appended claims and their equivalents

What is claimed is:

1. A pressure-sensing valve, comprising:
a first housing part, formed with an inner space, a side opening, an upper threaded hole at upper end, and a conic surface at lower end;
a second housing part, formed with a inner space engaged with the lower portion of the first housing part, a lower threaded hole and a outlet hole communicated with the inner space through the side opening;
a first regulating knob, formed with a first threaded bolt threadly engaged with the upper threaded hole, and a slender air passage to allow an airflow passing axially therethrough;
a second regulating knob, formed with a threaded bolt threadly engaged with the lower threaded hole, and an air passage to allow an airflow form an inlet hole to pass axially therethrough;
a valve piston, having a air-tight slider slidably received within the inner space of the first housing part, and a gating portion to air-tightly engaged with the conic surface of the first housing part.
a pair of springs, received within the inner spaces of the first and second housing part respectively for biasing the valve piston on both ends thereof;
an upper washer movably received within the inner spaces of the first housing part between the first regulating knob and one of the springs; and
a lower washer movably received within the inner spaces of the second housing part between the second regulating knob and one of the springs.

2. The pressure-sensing valve as claimed in claim 1, wherein the first threaded bolt is threadly engaged with the upper threaded hole thereby to adjust back and forth into the inner space, to abut against the upper washer to compress the springs.

3. The pressure-sensing valve as claimed in claim 1, wherein the second threaded bolt is threadly engaged with the lower threaded hole thereby to adjust back and forth into the inner space, to abut against the lower washer to compress the springs.

4. The pressure-sensing valve as claimed in claim 1, wherein the gating porting is formed with a conic surface for engaging with the conic surface of the first housing part.

5. The pressure-sensing valve as claimed in claim 1, wherein the inlet hole is capable of connecting with a second air cleaner.

6. The pressure-sensing valve as claimed in claim 1, wherein the inlet hole is capable of connecting with a second air cleaner and a breather hose simultaneously thereby to communicate with outside air and a crankcase of engine.

7. The pressure-sensing valve as claimed in claim 1, wherein the valve piston is adjustably moving to a gating position by rotating the first regulating knob and the second regulating knob.

8. The pressure-sensing valve as claimed in claim 1, wherein the upper threaded hole and the outlet are capable of communicating to an intake manifold of an engine simultaneously.

9. A method of using the pressure-sensing valve as claimed in claim 1, comprising:
a step for connecting the slender air passage and the outlet hole to an intake manifold of an engine;
a step for connecting the inlet hole to a second air cleaner;
a step for rotating the first regulating knob and the second regulating knob to adjust the valve piston to a gating position.

10. The method as claimed in claim 9, further includes a step of compressing the pair of springs to a compressed length that allows the gating portion of the valve piston disengaged from the conic surface of the first housing part temporarily, during the engine is in acceleration.
